(19) United States
(12) Patent Application Publication
(10) Pub. No.: US 2005/0214950 A1
(43) Pub. Date: Sep. 29, 2005

(54) Optical disk based gas-sensing and storage device

(76) Inventors: Jeffrey F. Roeder, Brookfield, CT (US); Thomas H. Baum, New Fairfield, CT (US)

Correspondence Address: INTELLECTUAL PROPERTY / TECHNOLOGY LAW, PO BOX 14329, RESEARCH TRIANGLE PARK, NC, 27709, US

(21) Appl. No.: 10/807,020

(22) Filed: Mar. 23, 2004

(51) Int. Cl. G01N 21/00

(52) U.S. Cl. 436/165; 422/83

(57) ABSTRACT

An optical disk based gas-sensing and storage system for sensing toxic gas species or environmental contaminants and recording such events on an optical data storage disk. The system includes a gas-retaining unit having an internal cavity for retaining a gaseous sample potentially comprising a gas species of interest, an optical storage disk arranged for contact with the gaseous sample in the gas-retaining unit, wherein the optical data storage disk includes a gas-sensing medium that exhibits a physical and/or chemical property change when exposed to the gas species of interest thereby generating optically readable signals, and a laser energy source positioned to irradiate the optical data storage disk to detect and/or enhance changes in chemical and/or physical properties of the gas-sensing medium and record optically readable signals.

### BACKGROUND OF THE INVENTION

1. Field of the Invention

The present invention relates generally to a sensor device, more specifically, to an optical disk based gas-sensing device and method of using same, having utility for monitoring of toxic gases and environmental contaminants generated in semiconductor process operations.

2. Description of the Related Art

The semiconductor industry uses a number of highly toxic gases or otherwise hazardous gas components, particularly arsine, germane, silane, phosphine, and diborane, in the manufacture of semiconductor devices. Industry guidelines recommend threshold limit values (TLVs) for each of these gases that represent the maximum time-weighted average concentration a worker should be exposed to in an eight-hour period. The American Conference of Governmental Industrial Hygienists has recommended a threshold limit value of 0.05 and 0.3 ppm respectively for arsine and phosphine. Thus, the detection of even small concentrations of these gases is crucial. As these gases are colorless, non-irritating, and have only a mild odor, the failure to detect exhaustion of these gases may result in deleterious exposure of plant personnel to hazardous gases, as well as environmental contamination in the ambient surroundings of the semiconductor process facility.

Applications in which such monitoring is carried out include monitoring of process streams to determine the end point utility of a specific scrubbing treatment of such streams to remove hazardous gas components therefrom, and monitoring of sample gas for toxic gas components. A number of systems and techniques have been developed for monitoring a process stream or an ambient environment in the semiconductor manufacturing industry for the presence of these toxic or otherwise hazardous gas components. Current toxic gas sensors and central monitoring systems are based on a variety of technologies. These systems include: sensitized paper tapes, acoustic sensors, FTIR based sensors, mass spectroscopy and other analytical methods.

The paper tape system involves the use of costly devices that require significant maintenance with replacement of consumable elements, e.g., the frequent change of color tapes or frequent change of cells in monitors that require biweekly paper tape changes or monthly cell changes. Although the paper tapes provide a permanent record of sensing events, the thermal stability of the material used in fabricating the tape is questionable and to ensure its stability it must be stored under refrigeration prior to use. Moreover, the bulky size of the sensing system, including the tapes, uses valuable space within a processing facility, and thus, increases cost of ownership. While other sensing methods are viable for detection of gases, they have the disadvantage of not providing physical archival evidence of the sensed event.

Thus, it would therefore be an improvement in the art of gas monitoring to provide a monitoring device, which requires little routine maintenance, possesses a high level of sensitivity and accuracy and also provides an archival record of gas stream monitoring for the presence of contaminants or toxic species.

### SUMMARY OF INVENTION

The present invention relates generally to a gas-sensing and storage device and method for sensing toxic gas species or environmental contaminants in an environment susceptible to the presence of such species, such as an ambient environment or a gaseous sample stream from a semiconductor manufacturing process.

In one aspect, the present invention relates to an optical gas sensor for monitoring a gas species of interest in a gaseous sample comprising:
a) an optical storage disk arranged to contact the gas sample, wherein the optical data storage disk comprises a gas-sensing medium that exhibits a physical and/or chemical property change when exposed to the gas species of interest thereby creating an optically readable signal.

In another aspect, the present invention relates to an optical gas sensor system for monitoring a gas species of interest in a gaseous sample comprising
a) a gas-retaining unit comprising an internal cavity for retaining a gas sample;
b) an optical storage disk arranged for contact with the gaseous sample in the gas-retaining unit, wherein the optical data storage disk comprises a gas-sensing medium that exhibits a physical and/or chemical property change when exposed to the gas species of interest thereby generating optically readable signals; and
c) a laser energy source positioned to irradiate the optical data storage disk to detect changes in chemical and/or physical properties of the gas-sensing medium.

In yet another aspect, the present invention relates to a gas sensor system for monitoring a gas species of interest in a gaseous sample comprising
a) a gas-retaining unit comprising an internal cavity for retaining a gaseous sample during a sampling period;
b) a layer of gas-sensing medium supported on an optically transparent support, wherein the gas-sensing medium is arranged for exposure to the gaseous sample and wherein the gas-sensing medium exhibits a chemical and/or physical property change when exposed to the gas species of interest;
c) a laser energy source positioned to irradiate the gas-sensing medium to detect a chemical and/or physical property change and record detected changes to a recordable optical storage disk.

Another aspect relates to a method of detecting a gas species of interest in a gaseous sample, the method comprising:
a) providing a sensor comprising a gas-sensing medium that exhibits a physical and/or chemical property change when exposed to the gas species of interest;
b) exposing the gas-sensing medium to the gaseous sample; and
c) monitoring chemical or physical property changes in the gas-sensing medium to determine presence of the gas species of interest.

In another aspect the present invention relates to an optical gas sensor system for monitoring a gas species of interest in a gaseous sample comprising:
a) a gas-retaining unit comprising an internal cavity for retaining a gaseous sample suspected of containing a gas species of interest during a sampling period;
b) an optical data storage disk comprised of at least one gas-sensing medium, wherein the gas-sensing medium is communicatively connected to the internal cavity, and wherein the gas-sensing medium is susceptible to the formation of optically readable signals after contact with the gas species of interest in the gaseous sample.

In another aspect, the present invention provides a gas sensor system for monitoring a gas species of interest in a gaseous sample comprising:
a) a gas-retaining unit comprising an internal cavity for retaining a gaseous sample comprising a gas species of interest during a sampling period;
b) at least a section of a gas-sensing medium arranged for contact with the gaseous sample in the internal cavity, wherein the gas-sensing medium is susceptible to a physical and/or chemical property change after contact with the gas species of interest in the gaseous sample, thereby forming optically readable signals;
c) a laser-energy source communicatively connected to the internal cavity and positioned to optically detect any optically readable signals;
d) a writable CD-ROM disk arranged to receive an emerging laser energy beam after transmission through or reflection from the gas-sensing medium for storage of detected optically readable signals.

Another aspect of the present invention relates to a method for sensing the presence of a gas species of interest in a gaseous sample, the method comprising:
a) exposing a gas-sensing medium to a gaseous sample comprising a gas species of interest, wherein the gas-sensing medium is susceptible to the formation of optically readable signals after contact with the gas species of interest;
b) irradiating the gas-sensing medium with a laser energy beam to detect optically readable signals formed in the gas-sensing medium after contact with the gas species of interest;
c) transmitting the optically readable signals to a writable CD-ROM for recording and storage thereon.

A still further aspect relates to a sensing system comprising:
a) a gas-retaining unit comprising an internal cavity for retaining a gaseous sample suspected of containing a gas species of interest during a sampling period;
b) an optical data storage disk comprised of at least one gas-sensing medium, wherein the gas-sensing medium is communicatively connected to the internal cavity;
c) a laser-energy source communicatively connected to the internal cavity for irradiating the gas-sensing medium with an effective frequency to enhance a chemical reaction between the gas-sensing medium and the gas species of interest thereby producing optically readable signals.

Other aspects and advantages of the invention will be more fully apparent from the ensuing disclosure and appended claims.

### BRIEF DESCRIPTION OF THE DRAWINGS

FIG. 1 illustrates one embodiment of an optical disk based gas-sensing system of the present invention.

FIG. 2 illustrates an optical storage disk comprising multiple layers.

FIG. 3 illustrates another embodiment of the present invention comprising a non-integrated gas-sensing medium irradiated with laser energy beam from a laser energy source positioned to reflect a laser energy beam from the gas-sensing medium.

FIG. 4 illustrates another embodiment of the present invention comprising a non-integrated gas-sensing medium irradiated with laser positioned to transmit a laser light beam through the gas-sensing medium.

FIG. 5 illustrates an optical storage disk comprising multiple layers wherein the gas-sensing medium senses and stores data in a spiral track.

### DESCRIPTION OF PREFERRED EMBODIMENT OF THE INVENTION

Generally, the present invention is a gas-sensing system that includes a gas-sensing medium that upon exposure to a gas species of interest, the gas-sensing medium exhibits changes in physical and/or chemical properties, such as an optical property relating to the change from an opaque phase to a transparent phase. These optical changes are recordable and optically readable.

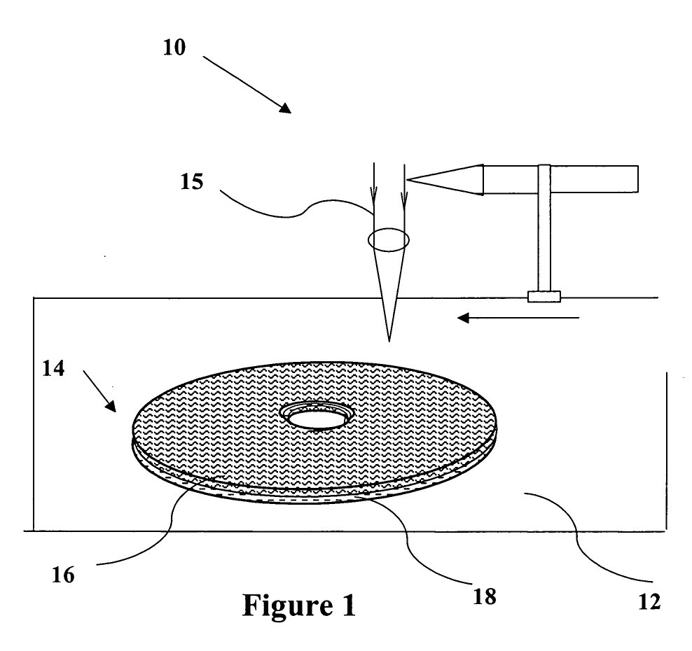

FIG. 1 depicts one embodiment of an optical gas-sensing system 10 of the present invention comprising a gas-sensing area including an a disk 14 that includes at least a gas-sensing medium 16 applied to a supporting substrate 18, wherein the gas-sensing medium is susceptible to at least one physical and/or chemical property change thereby generating an optically readable signal. A gaseous sample is introduced into the sampling area for contacting the gas-sensing medium for a sufficient sampling period to determine the presence of a gas species of interest in the gaseous sample. The system further comprises a system 15 for detecting optically readable changes recorded on the gas-sensing medium. Additionally and optimally, the laser power can be adjusted to provide local heating to enhance the speed of the chemical or physical response of the sensing medium layer.

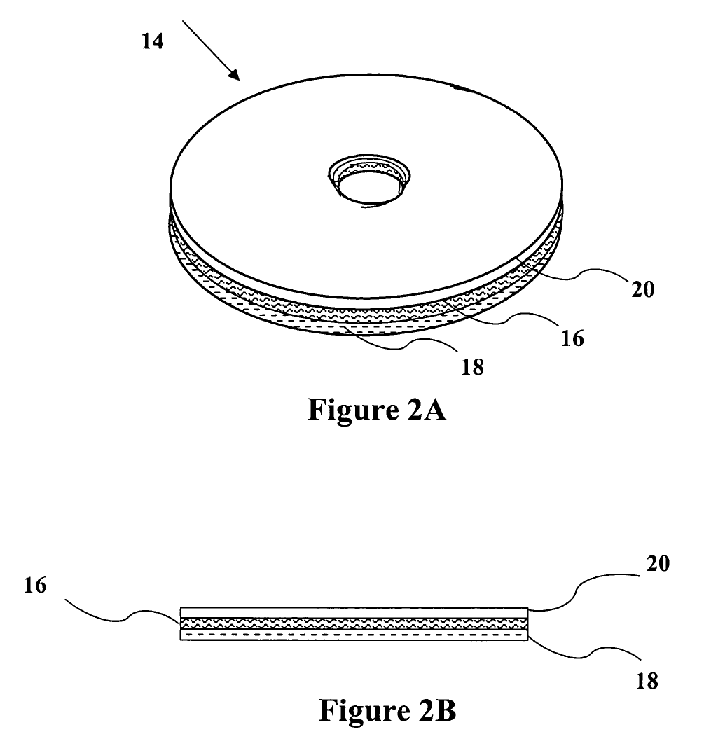

FIG. 2 illustrates an optical data storage disk 14 of the present invention, which comprises a supporting substrate 18 that is sufficiently thick and rigid to provide structural integrity to the overlying mediums or layers. Preferably, the supporting substrate is fabricated from a material that remains structurally strong and rigid throughout the range of temperatures encountered during recording (writing) or reading by a laser source. Additionally, the supporting substrate should not deform substantially in response to possible expansive forces that may occur during any heating mode. More preferably, the thickness of the supporting substrate is from one micron to one millimeter. The supporting substrate can be fabricated from transparent or opaque materials including, but not limited to, glass, ceramics, metallic plates or sheets of aluminum, stainless steel, plastics made of polycarbonate, polyvinyl chloride, polymethyl methacrylate. Preferably, the supporting substrate is a rigid transparent material, which permits substantially full transmission of a laser light beam from a laser source, whether the laser light beam is in a writing mode or reading mode. More preferably, the transparent material may include glass, polymethyl methacrylate, polycarbonate, polyvinyl chloride, or polyethylene terephthalate.

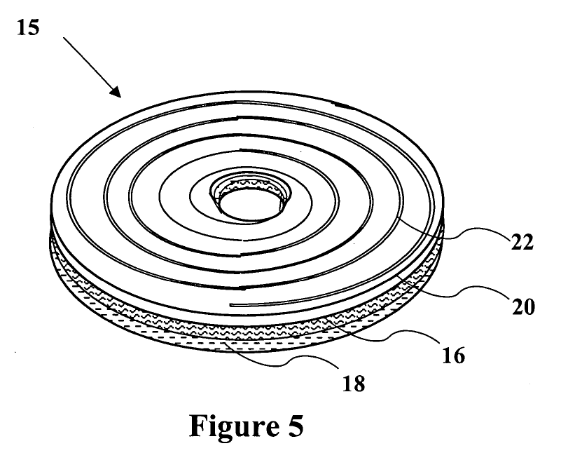

A gas-sensing medium 16 is applied the entire surface of the supporting substrate, or in the alternative at least to a portion of the surface of the supporting substrate, such as shown in FIG. 5 wherein the gas-sensing medium is sensing gas medium is embedded in the spiral groove that may be stamped into the supporting substrate. The gas-sensing medium includes a gas reactive material that is sorptively, either chemically and/or physically, effective in forming a reaction product when interacting with the gas species of interest.

For example the gas-sensing medium may include a rare earth metal material that upon exposure to a gas species of interest, such as hydrogen, exhibits striking changes in physical properties, such as optical properties, wherein the material changes from metallic (opaque) to semiconducting (transparent) phases, such as described in U.S. Pat. No. 6,006,582, the contents of which are hereby incorporated by reference herein.

In a preferred practice of the invention, the rare earth metal material is applied as a thin film on the supporting substrate 18 and then can optionally be overlaid by a protective layer 20 which is permeable to the gas-species of interest, but which is at least highly impermeable to reactive species that could otherwise deleteriously interact with the rare earth metal and prevent it from producing the desired physical property change of the film upon exposure with the gas species of interest.

As used herein, the term “rare earth metal” means a metal selected from scandium, yttrium, lanthanum, the lanthanides, as well as alloys and combinations of such metals, and alloys and combinations of such metals with Group II elements calcium, barium, strontium and magnesium. The lanthanides are the 13 elements following lanthanum in the Periodic Table. Useful lanthanides include cerium, praseodymium, neodymium, promethium, samarium, europium, gadolinium, terbium, dysprosium, holmium, erbium, thulium and ytterbium.

The physical property altered in response to the presence of a gas species of interest may be the optical transmissivity of the film to radiation incident on the gas-sensing medium as transmitted by a laser source. The change in physical property of the rare earth metal thin film is readily monitored, to provide an output indicative of the presence of gas species of interest in the environment to which the rare earth metal is exposed.

The aforementioned optical property changes in rare earth thin films, incident to their exposure to gas species of interest, such as hydrogen, result from a chemical equilibrium between the dihydride and trihydride forms. The dihydride form of the rare earth thin film is opaque and reflecting, whereas the trihydride form of the film is transparent. When hydrogen is present as the gas species of interest, a dynamic equilibrium exists between the two forms and the physical and optical changes can be quite dramatic.

For example, in the presence of hydrogen, noble metal (e.g., Pd, Pt) overcoated Y reacts to form the dihydride (YH₂). Further exposure to hydrogen results in the formation of the trihydride YH₃. This second step occurs at room-temperature and ambient pressure and is completely reversible. The formation of YH₂, on the other hand, is essentially irreversible as a result of its relatively large heat of formation (−114 kJ/mol H) compared with the equilibrium step (−41.8 kJ/mol H or −44.9 kJ/mol H).

Additional gas-sensing mediums that provide for optically readable signals after interaction with a gas species of interest may include a material that forms a different crystal structure after interaction with a gas species of interest. Such a material has at least two separate spectral reflectances at different temperatures of heating. Thus, an ideal material has different phases of crystal structures in at least two temperature regions. Examples of such materials include an alloy comprising silver as a main component and one of 30 to 45% of zinc and 6 to 10% of aluminum, an alloy comprising copper as the main component and at least 10 to 20% of aluminum, 20 to 40% of indium, and 15 to 35% of tin, an alloy comprising gold as the main component, with 2 to 5% of aluminum. All these alloys may further comprise a small amount of the groups VIII, Ib, IIb, IIIb, IVb, Vb, VIb, and VIIa.

In another embodiment of the present invention, the gas-sensing medium may comprise a mixture or an integrated layer of at least two materials that react with each other in an exothermic reaction upon interaction with a gas species of interest. The two materials may comprise a metal and an oxide that have a standard enthalpy of formation higher than that of the oxide obtained by oxidation of the metal. When a specific area of the gas-sensing medium is exposed to the gas species of interest, the gas-sensing medium is heated to a higher temperature whereby the oxide including in the gas-sensing medium is reduced into a metal while the metal is accordingly oxidized into an oxide. As a result, the specific area of the exposed gas-sensing medium changes in an optical constant that provides a readable signal.

Other chemically active materials may be used for gas-sensing mediums. For example, specific gas species can form metal complexes via chemical chelation that will result in a change in optical constants thereby detecting the presence and quantity of a gas species of interest. For example, AsH₃ and PH₃ can be determined in a gaseous sample by coordination to substrate comprising a cage molecule or suitably substituted polymeric materials. Still further the gas-sensing medium may include a polymer that binds with the gas species of interest in a chemical change.

Generally, the gas-sensing medium 16 will be of a suitable thickness to provide appropriate sensitivity and responsivity characteristics for the gas-sensing application. The gas-sensing medium may have a thickness of several Å to several mm, preferably from 700 Å to 1.8 mm. More preferably, the gas-sensing medium has a thickness of less than about 50 microns, and most preferably, from about 0.001 to about 0.10 microns.

FIG. 1 illustrates the gas-sensing medium applied to a circular data storage disk, which is exposed to the gaseous sample to cause a physical or chemical property change in the gas-sensing medium that provides optically readable signals. In one embodiment, the entire wafer is exposed to the gaseous sample and continually indexed so that when a sensing event occurs, it is located and recorded at a certain spot corresponding to the location of the laser beam. In another embodiment, only a small section of the gas-sensing medium is exposed to the gaseous sample during a sensing event. As a section of the gas-sensing medium is exposed to the gaseous sample, the circular data storage disk is rotated by any means known to one skilled in the art thereby exposing a new section of the gas-sensing medium for each subsequent sampling period.

The exposed section of the gas-sensing medium may be monitored to determine if any optically readable signals have been generated due to interaction with a gas species of interest. This monitoring is accomplished by positioning a laser source, either above or below the optical disk, to read the signals formed during the previous sensing event. Any laser source may be used in the present invention including, but not limited to diode lasers that generate a highly monochromatic beam, that is composed of a single wavelength or color. This reading of the optically readable signals provides for a monitoring system that alerts personnel when a specific concentration of a toxic gas is present in the gaseous sample.

During the sensing event, the optically readable signals may include transparent and/or opaque regions formed in the gas-sensing medium that exhibits different reflectance constants when exposed to a laser light beam. In general, a beam of light is directed from a laser to the surface of the gas-sensing medium and reflected therefrom or transmitted therethrough. The reflected or transmitted beam of light is routed to a writable CD ROM, for storage thereon.

Depending on the specific gas-sensing medium and the interaction of the gaseous sample with the gas-sensing medium, the optical data storage disk may further comprise a protective layer 20, as shown in FIG. 2, which covers the gas-sensing medium with a material that is transparent to the irradiation by a laser source, yet permeable to the gas species of interest. For example, the transparent protective material may include, but not limited to, glass, polymethyl methacrylate, polycarbonate, polyvinyl chloride, polyethylene terephthalate, etc.

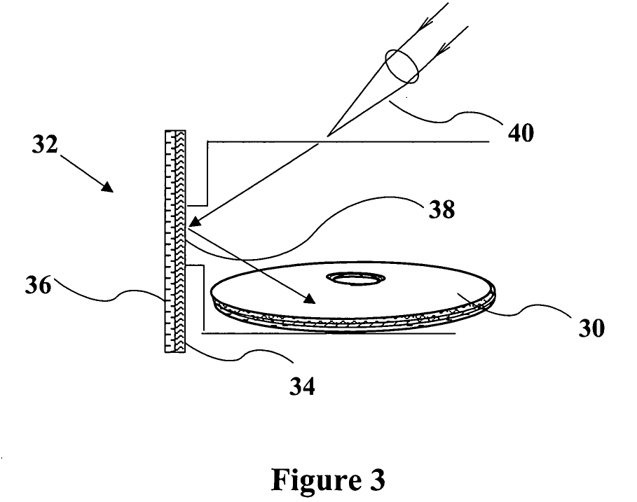

FIG. 3 illustrates another embodiment of the present invention having a sensing assembly 32 comprising a gas-sensing medium 34 on a support substrate 36 that is exposed to a gaseous sample for interaction therewith to form optically readable signal within the sensing medium. The gas-sensing medium can be any length, and optionally only a section 38 of the gas-sensing medium is exposed during a specific sampling period. After the section of the gas-sensing medium is exposed during a sampling period a new section of the gas-sensing medium may be moved into place for exposure to another sample of the gaseous sample.

The gas-sensing medium 32 may include any of the mediums discuss hereinabove that provide for optically readable signals including absorptive material, phase-change material, oxidation-reduction reaction combinations, or materials that reversibly transform from one phase to another phase (opaque to transparent) on exposure to a gas species of interest.

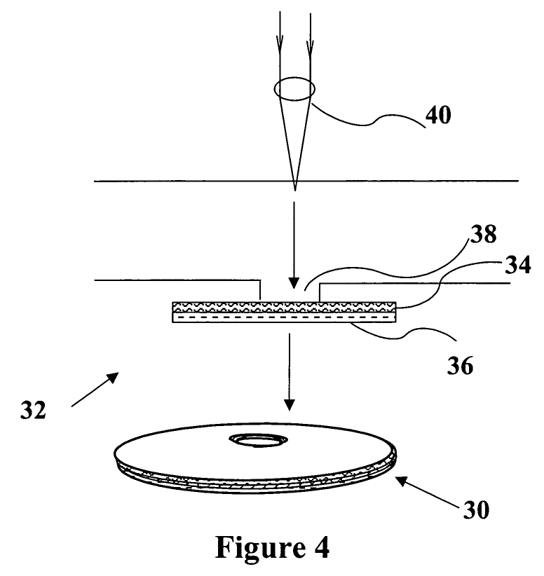

An energy beam emitted from a laser source 40 may be reflected from the gas-sensing medium as shown in FIG. 3 or transmitted through the gas-sensing medium and substrate as shown in FIG. 4, thereby reading the optically readable signals and recording such signals on a writable optical data storage disk 30 for storage thereon. The writable optical data storage disk may comprise a transparent supporting substrate 52, a layer of photosensitive dye 54 as a recording medium and a smooth reflective metal layer 56 applied on the photosensitive dye. When the disk is blank, the dye is translucent and thus a light energy beam 58 light can shine through and reflect off the metal surface. When the dye is heated due to the laser beam transmitting or reflecting from the optical readable signals in the sensing medium, the dye turns opaque. It can darken to a point the prevent lights from passing therethrough. By darkening particular points along a track, while other areas are translucent, a digital pattern is created that can be read by a laser in a reading mode.

The embodiment illustrated in FIG. 5 shows a track 22 having a configuration of a spiral for recording information therein. The track 22 shows that a sensing event can be recorded similar to the track of grooves on a phonograph record. In the alternative, a recessed groove can be stamped into supporting substrate 18 along the spiral track 22. The grooves may be are included to guide the reading and/or recording laser beam and also provide a predetermined track for including a gas-sensing medium that is susceptible to change in at least one physical and/or chemical property, wherein the change in property generates optically readable signals.

The grooves embedded in the supporting substrate are of dimensions selected in accordance with the supporting substrate material, gas sensing medium and optics of the laser system. In general the grooves have a depth ranging from about 0.4 microns to about 1 micron. The geometry of the groove, i.e. the profile of the cross-section may vary, although preferably the geometry of the groove is a recess having sharp edges and more preferably the angle between the walls and floor of a typical groove is approximately 90°. Generally, the width of the groove is sufficient to include a gas-sensing medium in an amount to provide optically readable signals after interaction with a laser beam or contact with a gas species of interest. Preferably, the width of the groove is approximately one/half of the depth of the grooves, and more preferably range from about 0.2 to about 6 micron and a mutual center spacing of approximately 1 to 2 microns.

In the embodiment illustrated in FIG. 5, the gaseous sample is introduced into an internal cavity that is configured so that a small section of the gas-sensing medium 16 in the track 22 is exposed to the gaseous sample and/or the laser light beam during a sampling period. Thus, only the gas-sensing medium included in the exposed section groove is exposed during a specific sensing period. As a section is exposed to the gaseous sample the circular optical data storage disk is rotated by any means known to one skilled in the art thereby exposing a new section of the gas-sensing medium for a new sampling. Preferably, the rate of rotation is controlled to ensure long period of detections.

In operation, a gaseous sample that potentially contains a specific gas of interest is introduced into the internal cavity 12, as shown in FIG. 1. The internal cavity can be any size or configuration including a sphere, ellipsoid, barrel, cylinder, or a combination of these shapes and preferably fabricated from a material that is non reactive with the gaseous sample and any gaseous species of interest contained therein. Preferred materials include stainless steel, aluminum, aluminum alloys, nickel clad, stainless steel, graphite and/or ceramic material.

The gas-sensing medium is exposed to the gaseous sample and any gas species of interest contained therein will cause a physical and/or chemical property change in the gas-sensing medium thereby generating an optically readable signal. This optically readable signal can be read directly by a laser and detected by a detection unit or stored on a separate writable CD ROM disk.

Although the invention has been variously described herein with reference to illustrative embodiments and features, it will be appreciated that the embodiments and features described hereinabove are not intended to limit the invention, and that other variations, modifications and other embodiments will readily suggest themselves to those of ordinary skill in the art, based on the disclosure herein. The invention therefore is to be broadly construed, consistent with the claims hereafter set forth.

1. An optical gas sensor system for monitoring a gas species of interest in a gaseous sample comprising
a) a gas-retaining unit comprising an internal cavity for retaining a gas sample; and
b) an optical storage disk arranged for contact with the gas sample in the gas-retaining unit, wherein the optical data storage disk comprises a layer of a gas-sensing medium that exhibits a physical and/or chemical property change when exposed to the gas species of interest thereby generating optically readable signals; and
c) a laser energy source positioned to irradiate the optical data storage disk to detect changes in chemical and/or physical properties in the gas-sensing medium layer.

2. The system according to claim 1, wherein the gas-sensing medium is a phase-change material, an oxidation-reduction reaction material, a heat reactive material or a polymer that binds the gas species in a chemical change.

3. The system according to claim 1, wherein the gas-sensing medium is a rare earth metal material that upon exposure to a gas species of interest exhibits a change in optical properties.

4. A gas sensor system for monitoring a gas species of interest in a gaseous sample comprising:
a) a gas-retaining unit comprising an internal cavity for retaining a gaseous sample during a sampling period;
b) a layer of gas-sensing medium supported on an optically transparent support, wherein the gas-sensing medium is arranged for exposure to the gaseous sample and wherein the gas-sensing medium exhibits a chemical and/or physical property change when exposed to the gas species of interest; and
c) a laser energy source positioned to irradiate the gas-sensing medium to detect a chemical and/or physical property change and record detected changes to a recordable optical storage disk.

5. The system according to claim 4, wherein the recording medium is susceptible to the formation of optically readable signals after contact with the gas species, thereby detecting the gas species.

6. The system according to claim 4, wherein the optical data storage disk comprises a spiral track for recording in the gas-sensing medium.

7. The system according to claim 4, wherein the gas-sensing medium is deposited on the surface of the optically transparent support.

8. The system according to claim 4, wherein the property change comprises, a phase-change, mass change, or optical property change.

9. The system according to claim 4, wherein the gas-sensing medium generates an optically readable signal after interaction with the gas species of interest.

10. The system according to claim 4, wherein the gas-sensing medium is a rare earth metal material overcoated with Pd for detection of hydrogen gas.

11. The system according to claim 6, wherein only a section of the gas-sensing medium is exposed to the gaseous sample during a sampling period and is recorded in the gas-sensing medium.

12. The system according to claim 11, wherein the optical data storage disk is rotated after a sampling period thereby exposing a new section of the gas-sensing medium for a new sampling period.

13. The system according to claim 10, wherein the gas-sensing medium comprises a thermal recording material that when contacted by the gas species of interest exhibits a phase-change or optical change.

14. An optical gas sensor for monitoring a gas species of interest in a gaseous sample comprising:
an optical storage disk arranged to contact the gaseous sample, wherein the optical data storage disk comprises a gas-sensing medium that exhibits a property change when exposed to the gas species of interest, thereby creating an optically readable signal.

15. The optical gas sensor according to claim 14, further comprising a transparent support structure for depositing the gas-sensing medium thereon.

16. The optical gas sensor according to claim 14, wherein the property change comprises a phase-change, chemical change, or optical property change.

17. The optical gas sensor according to claim 15, wherein the optical data storage disk comprises a spiral track for depositing the gas-sensing medium.

18. The optical gas sensor according to claim 14, wherein only a section of the gas-sensing medium is exposed to the gaseous sample during a sampling period.

19. The optical gas sensor according to claim 14, wherein the optical data storage disk is rotated after a sampling period thereby exposing a new section of the gas-sensing medium for a new sampling period.

20. The optical gas sensor according to claim 19, wherein the rate of rotation is controlled to provide for long periods of detection.

21. The optical gas sensor according to claim 14, wherein the property change is physical and/or chemical.

22. A gas sensor system for monitoring a gas species of interest in a gaseous sample comprising:
a) a gas-retaining unit comprising an internal cavity for retaining a gaseous sample comprising a gas species of interest during a sampling period;
b) at least a section of a gas-sensing medium arranged for contact with the gaseous sample in the internal cavity, wherein the gas-sensing medium is susceptible to a physical and/or chemical property change after contact with the gas species of interest in the gaseous sample, thereby forming optically readable signals or changes;
c) a laser-energy source communicatively connected to the internal cavity and positioned to optically irradiate the gas sensing medium to detect any optically readable signals; and
d) a writable CD-ROM disk arranged to receive an altered laser energy beam after transmission through or reflection from the gas-sensing medium for storage of detected optically readable signals.

23. The system according to claim 22, wherein the altered laser energy beam is transmitted through the gas-sensing medium.

24. The system according to claim 22, wherein the altered laser energy beam is reflected from the gas-sensing medium

25. The system according to claim 22, further comprising a detection laser energy source positioned to illuminate through the rear of the CD-ROM and sensing layer.

26. The system according to claim 22, wherein the writable CD-ROM disk comprises a transparent supporting substrate, a layer of photosensitive dye and a reflective metal layer applied on the photosensitive dye

27. The system according to claim 22, wherein the gas-sensing medium is a polymer film.

28. The system according to claim 22, wherein only a specific section of the gas-sensing medium is exposed to the gaseous sample comprising the gas species of interest during a sampling period.

29. The system according to claim 22, wherein the gas-sensing medium is rotated after a sampling period thereby exposing a new section of the gas-sensing medium for a new sampling period.

30. The system according to claim 26, wherein the property change comprises, a phase-change, chemical change, or optical property change.

31. A method of detecting a gas species of interest in a gaseous sample, the method comprising:
a) providing a sensor comprising a gas-sensing medium that exhibits a physical and/or chemical property change when exposed to the gas species of interest;
b) exposing the gas-sensing medium to the gaseous sample; and
c) monitoring chemical or physical property change in the gas-sensing medium to determine presence of the gas species of interest.

32. The method according to claim 31, wherein monitoring the chemical or physical property change comprises:
a) irradiating the gas-sensing medium with a laser energy beam to detect optically readable signals formed in the gas-sensing medium after contact with the gas species of interest; and
b) transmitting the optically readable signals to a writable CD-ROM for recording and storage thereon.

33. The method according to claim 32, wherein the laser energy beam is altered after detecting optically readable signals.

34. The method according to claim 33, wherein the altered laser energy beam is reflected off the gas-sensing medium or transmitted through the gas-sensing medium.

35. The method according to claim 33, wherein the writable CD-ROM disk comprises a transparent supporting substrate, a layer of photosensitive dye and a reflective metal layer applied on the photosensitive dye.

36. The method according to claim 33, wherein the writable CD-ROM disk comprises a transparent supporting substrate and a polymeric thin film sensing layer.

37. The method according to claim 33, wherein only a section of the gas-sensing medium is exposed to the gaseous sample during a sampling period.

38. The method according to claim 32, wherein the property change comprises, a phase-change, chemical change, or optical property change.
